(19) United States
(12) Patent Application Publication
(10) Pub. No.: US 2011/0246501 A1
(43) Pub. Date: Oct. 6, 2011

(54) SYSTEMS AND METHODS FOR ENTITY REGISTRATION AND MANAGEMENT

(75) Inventors: Connor McMenamin, Cambridgeshire (GB); John Lear, San Diego, CA (US); Frank K. Brown, San Diego, CA (US)

(73) Assignee: Accelrys Inc., San Diego, CA (US)

(21) Appl. No.: 12/751,918

(22) Filed: Mar. 31, 2010

(51) Int. Cl. G06F 17/30

(52) U.S. Cl. 707/769; 707/802; 707/E17.005; 707/E17.014

(57) ABSTRACT

The disclosed embodiments contemplate an electronic storage system able to be rapidly deployed and subsequently used to receive and organize data entries. The system comprises a knowledge schema able to organize entries into a coherent form facilitating revision and review. The system may be implemented across a computer network such that users from a variety of locations may asynchronously review and update the database.

### BACKGROUND OF THE INVENTION

1. Field of the Invention

The field of invention relates to electronic databases.

2. Description of the Related Art

Database management systems (DBMS) provide useful means for more efficiently organizing data. Many databases comprise a relational database architecture comprising one or more multi-dimensional tables of data. Each table entry stores particular attributes of each record. The structure of the relational tables that store the data comprising the database is commonly referred to as the database schema.

Many of these databases are difficult to use, especially in a collaborative environment, where many users simultaneously create new records and edit existing ones. As users are rarely familiar with the internal organization of the database, they cannot anticipate the most efficient means for entering or editing entries. It is exceptionally tedious for users to anticipate duplicate entries, and namespace collisions when they enter new records into the system. Furthermore, managers generally do not have time to choose an optimal system architecture for a given collaborative effort, and must instead rely on expensive consultants, who may themselves be unfamiliar with the requirements of the collaborative team. Therefore, there is a need for a system that allows an organization to efficiently deploy a system to receive new records, and which will subsequently organize the records in a useful manner conducive to collaboration.

### SUMMARY OF THE INVENTION

In some embodiments, the invention comprises a method for electronically recording and organizing entities on a computer system, wherein each entity is associated with one or more attribute values. The method comprises defining one or more concept entities comprising a corresponding one or more sets of concept entity attribute values, receiving a plurality of field entries associated with an instance entity, the field entries comprising a plurality of instance entity attribute values, and determining, in the computer system, whether or not one or more of the plurality of field entries meet a defined criteria. If the one or more of the plurality of field entries meet the defined criteria, the instance entity is associated with an existing concept entity. If the one or more of the plurality of field entries do not meet the defined criteria, a new concept entity is created with a set of concept entity attribute values. In some of these embodiments, the method comprises comparing, in the computer system, at least some of the instance entity attribute values to one or more sets of concept entity attribute values to determine whether or not any of the one or more concept entities has the same compared attribute values as the instance entity. In this case, if the compared attribute values are the same for one of the concept entities and the instance entity, the instance entity is associated with the concept entity having the same attribute values, and if the compared attribute values are not the same for any of the concept entities and the instance entity, a new concept entity is created having the compared instance entity attribute values as concept entity attribute values.

A computer-readable medium comprising program code configured, when executed by a computer processor, to perform the steps of these methods is also provided.

In another embodiment, a database is implemented on a computer device, the database defining a plurality of entity classes, each of the classes being associated with a plurality of entities. Each of the entities within a class comprises one or more instance entities comprising a corresponding set of lot attribute values and a corresponding set of instance attribute values and one or more concept entities comprising a corresponding set of instance attribute values. In this embodiment, least some of the instance entities are associated with a concept entity having at least some of the same instance attribute values.

In another embodiment, a method is provided for electronically recording and organizing entities on a computer system, wherein each entity is associated with one or more attribute values. This method comprises entering a plurality of lot attribute values into a user interface of the computer system, entering a plurality of instance attribute values into a user interface of the computer system, creating, in the computer system, an instance entity having the specified lot and instance attribute values, and automatically creating at least one additional entity having at least some of the specified instance attribute values.

In another embodiment, a computer implemented system for electronically recording and organizing entities in a database, wherein each entity is associated with one or more attribute values. In this embodiment, the system may comprise means for defining one or more concept entities comprising a corresponding one or more sets of concept entity attribute values, means for receiving a plurality of field entries associated with an instance entity, the field entries comprising a plurality of instance entity attribute values, means for determining whether or not one or more of the plurality of field entries meet a defined criteria, means for associating the instance entity with an existing concept entity if the one or more of the plurality of field entries meet the defined criteria, and means for creating a new concept entity with a set of concept entity attribute values if the one or more of the plurality of field entries do not meet the defined criteria.

In another embodiment, a method for electronically recording and organizing entities on a computer device comprises receiving a new or edited entity record, the record comprising a plurality of field entries associated with a proposed instance entity, the field entries comprising a plurality of instance entity attribute values, applying at least one business rule to the entity record to determine if curation is necessary and curating the record. The curating comprises making the record available for review and editing by a curator, making the record available for review and editing by a scientist, based at least in part on the review of the curator, and again applying the business rules to the entity record to determine if curation is necessary.

### BRIEF DESCRIPTION OF THE DRAWINGS

FIG. 1 is a generalized diagram of a computer network topology implementing certain embodiments of the invention.

FIG. 2 is an illustration of the architecture of the system in certain embodiments of the invention.

FIG. 3 is an illustration of the relationship framework used in certain embodiments.

FIGS. 4A-4C illustrate screens for entering new entity attribute values.

FIG. 5 is a display of a stored concept entity showing the attribute values thereof.

FIG. 6 is a display of a uniqueness check presented to a user when registering a new entity.

FIGS. 7A-7E illustrate an example process of entity and relationship creation.

FIG. 8 is a display of a stored lot instance entity showing the attributes thereof and the relationships between this entity and other entities in the database.

FIG. 9A is an example concept entity search screen.

FIG. 9B shows the results of the concept entity search of FIG. 9A

FIG. 10A is an example instance entity search screen.

FIG. 10B shows the results of the instance entity search of FIG. 10A

FIG. 11 is a process flow diagram of the curation procedure found in certain embodiments.

### DETAILED DESCRIPTION OF THE PREFERRED EMBODIMENT

The following detailed description is directed to certain specific embodiments. However, the teachings herein can be applied in a multitude of different ways. In this description, reference is made to the drawings wherein like parts are designated with like numerals throughout. Although described with respect to a registration system for biological entities, one skilled in the art will readily recognize that the embodiments described herein may readily be transferred to any domain involving the entry of elements requiring identification and managed storage.

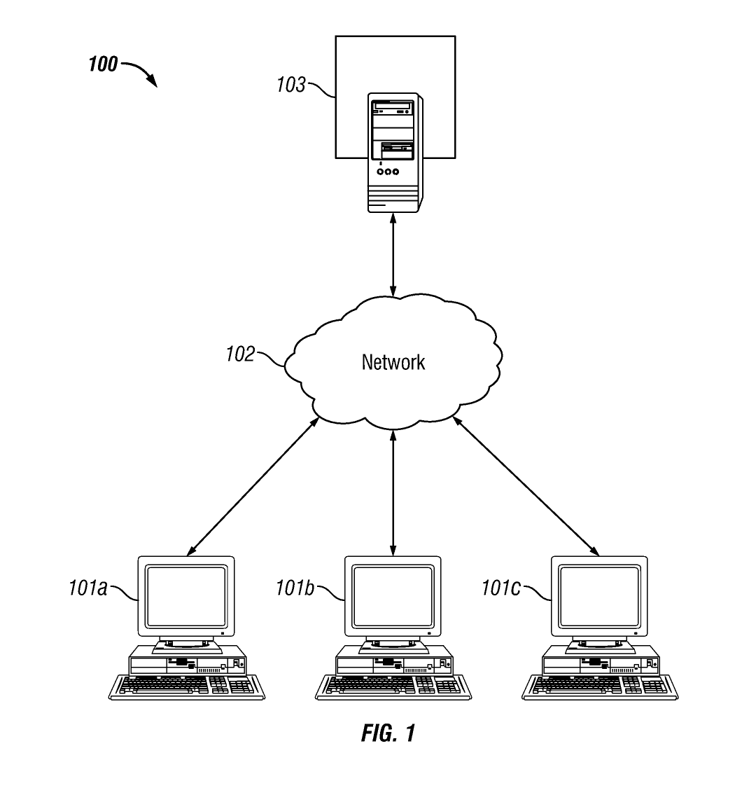

FIG. 1 illustrates a generalized diagram of a computer network topology implementing certain embodiments of the invention. As many collaborative environments must allow user access from a variety of locations with different hardware capabilities, the system should be intuitive and easy to run on commonly available computer systems and handheld devices. In addition, the user should be able to define the data to be stored in a way that mirrors the user's view of the data. Thus, the topology 100 illustrates how each of computer terminals 101a-c is connected via a network 102 to a central server system 103. Terminals 101a-c may be laptops, desktops, personal digital assistants, mobile devices, or other similar devices. Users may concurrently interact with the database stored on central server 103 via their terminals 101a-c. In some embodiments, the system may ensure an apparently seamless interaction from the perspective of a single user, although multiple users are simultaneously updating the server database 103.

In some embodiments the terminals 101a-c comprise displays for displaying registration screens, query results, and the like when using the system as well as user interface devices such as keyboards, touchscreens, etc. They also host local client software such as web-services for communication with the database 103. In some embodiments, the database server 103 communicates with the users at terminals 101a-c through email in addition or in lieu of a local client interface. Database server 103 may comprise an email server or similar software, to request peer review (by email) of edits to entries. The web client may provide an interface “shell” from which a user may, for example, log in, register new entries, define relationships between entities, search for entities, download or export data. Client-based java, javascript, flash suites, or similar browser-based development tools may be used for this purpose. Such client-side programs may be referred to as “lightweight” or “thin clients” since the data upon which they primarily operate is located remotely at the database server 103. In embodiments directed to biological entry registration, the server database 103 may provide services through the client software to a plurality of different users—for example, curators, scientists, and moderators, discussed in more detail below. The model may be stored on a “Structured Query Language” (SQL) server in communication with, or part of, the server 103. Users may send queries and commands via the client interface to the SQL server. In some embodiments the database server 103 comprises sets of rules dictating the server database's 103 operation. These rules may perform a variety of operations, described in detail below, such as uniqueness identification on receipt of new entries as well as curation.

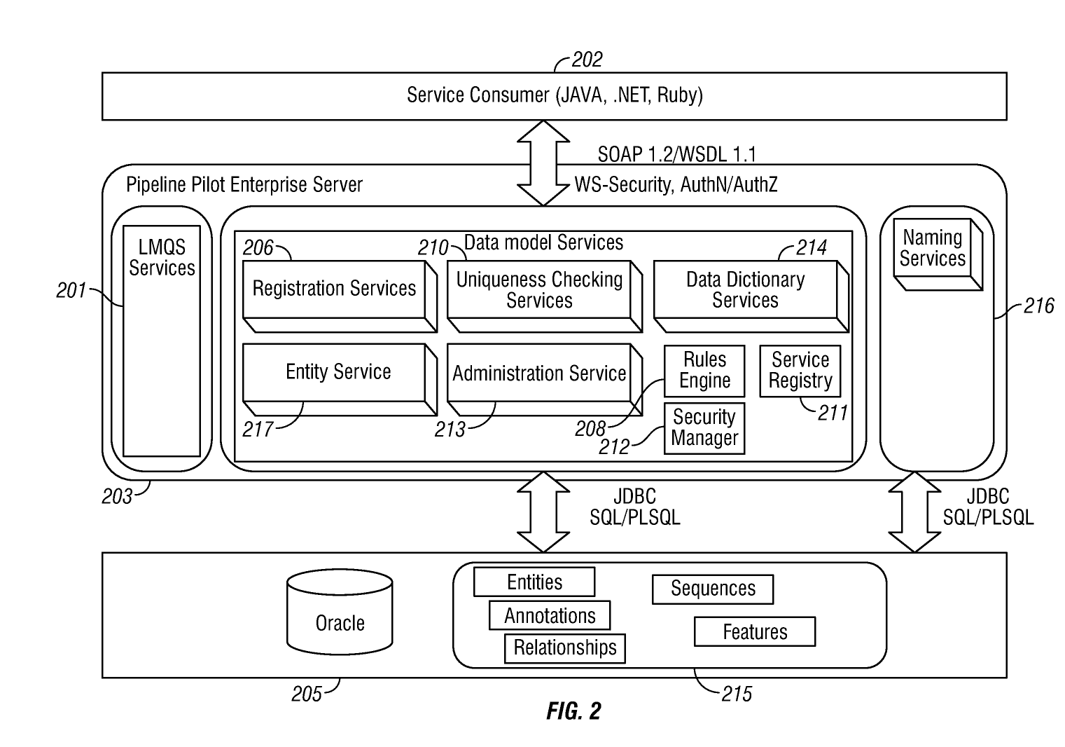

FIG. 2 illustrates various relationships between elements of database server 103 internally, and relationships with elements elsewhere in the network topology. In most embodiments, server 103 may comprise enterprise software 203 containing various tools for interacting with software 202, operating on terminals 101a-c. The client, or consumer, software 202, may be implemented in any language, including Java, Ruby, Javascript, etc. The enterprise software 203 may interact with database 205 (here shown as comprising SQL, although any database system may be used). The physical server 103 may comprise both the enterprise software 203 and database 205, or they may be operated separately.

Within the enterprise software 203, running perhaps as separate applications, which may themselves each be running simultaneously, are various data model services, comprising a registration service 206, entity service 217, rules engine 208, uniqueness checking service 210, a service registry 211, administration services 213, data dictionary services 214, and security manager 212. A naming service 216 may also be present and may be in separate communication with the database 205. Additional modules, common to the field and known in the art may also be present, which are used to monitor and maintain a database server and client.

### General Aspects of Knowledge Model

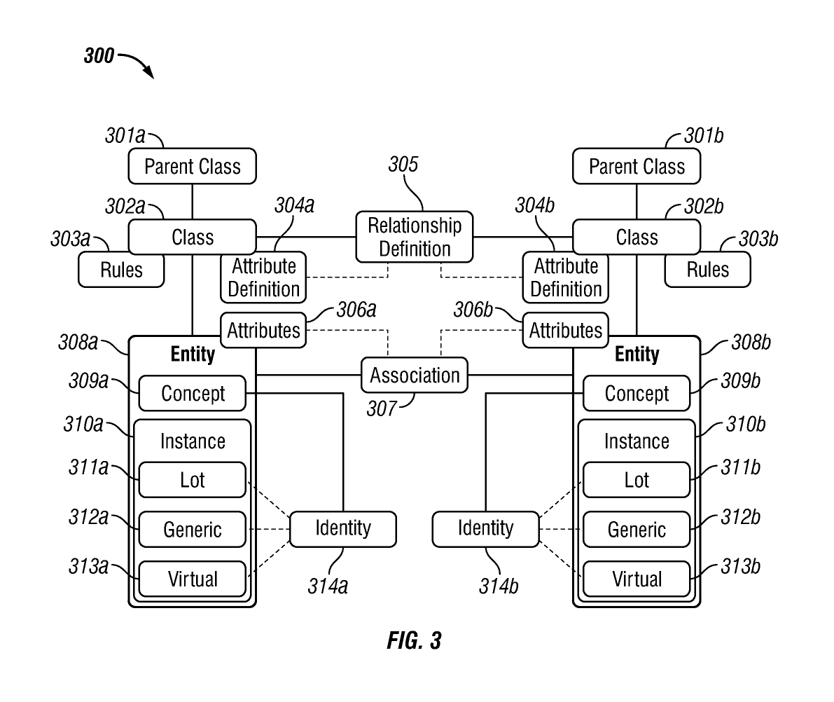

FIG. 3 is an illustration of the relationship schema used in certain embodiments. By this schema, entries are organized via a knowledge “hierarchy” or “tree” as shown in FIG. 3, comprising a variety of different classifications. The knowledge model in the registration system may comprise the following; Classes, Entities, Rules, Identities, Relationships and Attributes. Entities can be further defined as Concepts or Instances. Instances may have different types, referred to herein as Lots, Virtuals or Generics.

In the embodiment described specifically below, the database is used to manage information concerning biological entities such as antibodies, DNA sequences, and other items that are important in a biological research and drug discovery context. The aspects of the database described herein are especially applicable to such an environment because of the large volume of information generated during such investigations, and the need to recognize and define the relationships between the results of different experiments and other work performed by a large number of investigators working in parallel and often independent of one another. It will be appreciated, however, that the database architecture described below can be applied to a wide variety of contexts or “domains” of knowledge.

The registration system of FIG. 3 is based on a knowledge model that describes entities in terms their conceptual attributes, physical attributes, their relationships to other entities, and sets of business rules that evaluate those attributes to determine (among other things) uniqueness or identity between attributes being registered. As a result, the system can track not only the actual inventory of all registered biological entities, but also what other entities they are related to, derived from, or components of.

In conjunction with the schema described above, the system uses rules, also known as “Business Rules” in some embodiments, to configure system behavior and to dictate interactions among the above entities. For example, rules may be used to validate that appropriate values have been entered, to determine whether a new or existing identification can be used, to send emails, to manage curation, and to auto populate certain fields. Rules may be defined globally so that they apply to all classes, certain specific classes, or individually to a class.

Rules may be contained in a separate rules file, comprising its own syntax and generally have the following “if-then” form.

```
rule “name”
  when
    conditions
  then
    consequent
end
```

Rules 303a-b typically reside on the database server 103 and dictate the operations of the system. The rules not only handle the creation and editing of entries, but may also dictate what interactions may be engaged in by a particular user, and how those interactions are handled. These rules may be stored in a plurality of ways: directly in a file, indirectly as java or other source code, embedded in XML, etc. The rules engine 208 may be implemented with a program known as Drools, which is a Java open source business rule management system (BRMS) supplied by Red Hat. This allows flexibility for system administrators to write rules in a defined syntax that are applicable to the environment in which the system is implemented.

### Classes and Entities

As shown in FIG. 3, Classes 301a-b, 302a-b, comprise top level categories which may have pre-established rules and attribute definitions common to all entities within the class. Classes can be associated according to a hierarchy, so that rules and attributes can be defined and enforced at different levels. Child classes 302a-b may inherit some or all of these attributes and rules from the parent class in addition to having their own specific rules sets 303a-b and definitions for attributes 304a-b that members of a class may have.

As used herein, a “class” is a category of entity. An “entity” is a dataset comprising attribute values (which may also be called “annotations”), at least one of which will typically denote the class to which that entity belongs. As will be understood by those in the art, an attribute “value” may have any of a variety of forms, numeric, alphabetic, a combination of these, or it could be a file, a pointer, etc. Attribute values may include physical data, user data, data about relationships with other entities, and any other kind of information about an entity that is useful to users of the system.

In a database for storing information related to biological entities, parent classes may, for example, comprise classes of biological items such as Antibody, Protein, Plasmid, Cell Line, siRNA, DNA, Vaccine, etc. Each of these classes of items have a particular set of physical attributes associated with them that is defined by their physical nature and properties that the users of the registration system wish to store, search, and manage. Some or all of these classes may have child classes associated with them, such as the parent Antibody class may have Polyclonal and Monoclonal child classes. As also shown in FIG. 3, a class may have associated with it one or more entities. An entity is thus a stored dataset associated with a class, where the nature of the data in the dataset will be determined, at least in part, by the class to which that entity belongs. When a user of the database wishes to register an entity into the database, the user may specify the parent and/or child class, and the appropriate interface will be made available to enter the defining characteristics of the entity as attributes. Different classes may or may not share common attributes.

It is an important aspect of the system illustrated in FIG. 3 that entity types include both “concept” entities and “instance” entities. The simplest instance entity is referred to herein as a “lot instance.” A “lot instance” entity is a database entity that corresponds to a specific existing physical item. As a specific example, a class may be pre-defined as “Aqueous Solutions.” This class may have pre-defined attributes such as “amount,” “flask number,” “flask location,” and “solute composition.” When a scientist user creates a new aqueous solution, they specify the Aqueous Solution class, specify that they wish to register a lot instance of that class, and then receive a user interface allowing them to enter the attributes for entity members of this class. They may then enter an amount of 377 ml, flask number 782, Warehouse 5, sodium chloride. This will create a “lot instance” entity in the database corresponding to the physical sample made by the scientist.

A “concept” entity in the Aqueous Solutions class may include the subset of attributes of members of the Aqueous Solutions class that correspond to a particular chemical composition of aqueous solution, without the attributes associated with a specific physical sample of that solution. Thus, a concept entity may have the attribute solute composition, but will not have any attributes related to amount or location, as these attributes are characteristics of a specific sample, not a particular solution composition. In this case, the chemical composition defines an aqueous solution “concept,” and the amount, flask identification, and location identification, in addition to the composition, defines a “lot” that corresponds to a composition “concept” that shares the same solute composition attribute.

Generally, as used herein, “lot attributes” refers to attributes that have meaning in the context of an existing physical item. Attributes defining an amount, a storage location, and a production date are examples of lot attributes. “Instance attributes” are characteristics that may have meaning both with respect to specific physical items, and with respect to a particular type of physical item. An instance attribute may be chemical composition or structure, for example. In the system of FIG. 3, a “concept” entity is defined by the values of one or more instance attributes. A “lot” entity is defined by the values of one or more lot attributes and one or more instance attributes. The nature of the lot and instance attributes may be defined for a particular class, and will typically include some attributes which are the same and some which are different for different classes. Also, which instance attributes correspond to a “concept” within the class, and which may thus be termed concept entity attributes, may also be defined by the class.

Other types of instance entities in the system of FIG. 3 include generic instance entities and virtual instance entities. Generic instance entities 312a-b represent a generalized physical occurrence of an entity 308a-b. The attributes belonging to a generic entity are those defined as generic attributes. A generic entity may include more attributes than a concept, but may not include all of the attributes of a lot entity. This allows entities commonly used to be referenced in associations without having to specify a lot. For example, a class of Cell Line may include a generic entity of a commonly used cell line that has attributes defining a particular cell type, but does not have attributes defining a particular stored culture of that cell type.

Virtual entities 313a-b represent items that a given user might conceive of, but not have physically created, or at least for which no physical lot is available for registration for some reason. Thus, the attributes available in a given class may include attributes relevant to entities that can be inferred from the existence of physically generated items but have not been separated into a sample, or computationally generated items for which no physical sample has been produced. In this case, no physical sample exists, so some lot attributes will not be relevant, but some instance attributes can be given values to define the entity. For example, attributes for a class Drug Candidate Molecule might include a computed binding constant to a specified target or computed solubility estimate. This allows computationally generated occurrences to be recorded in the system.

Entities can correspond to things other than physical items as well, such as defined processes. A process entity might represent a production or storage process for example. Processes can also be categorized as concept and instance in a manner analogous to the above described physical items.

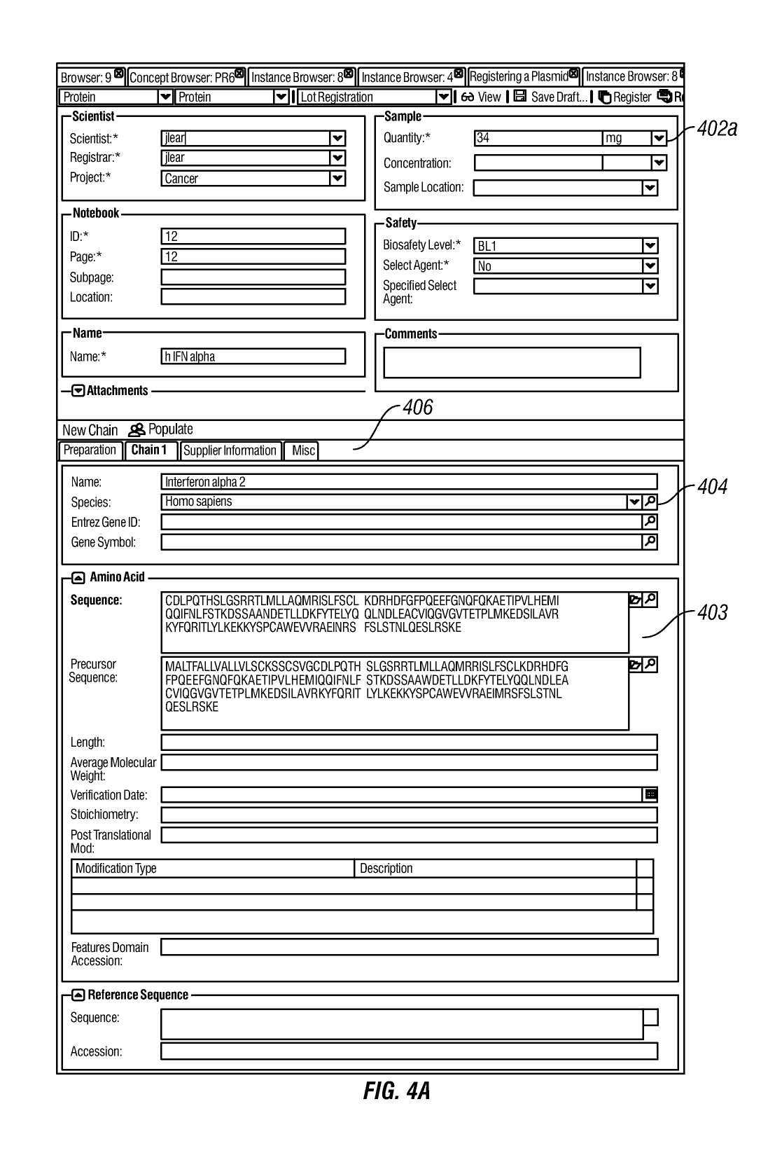

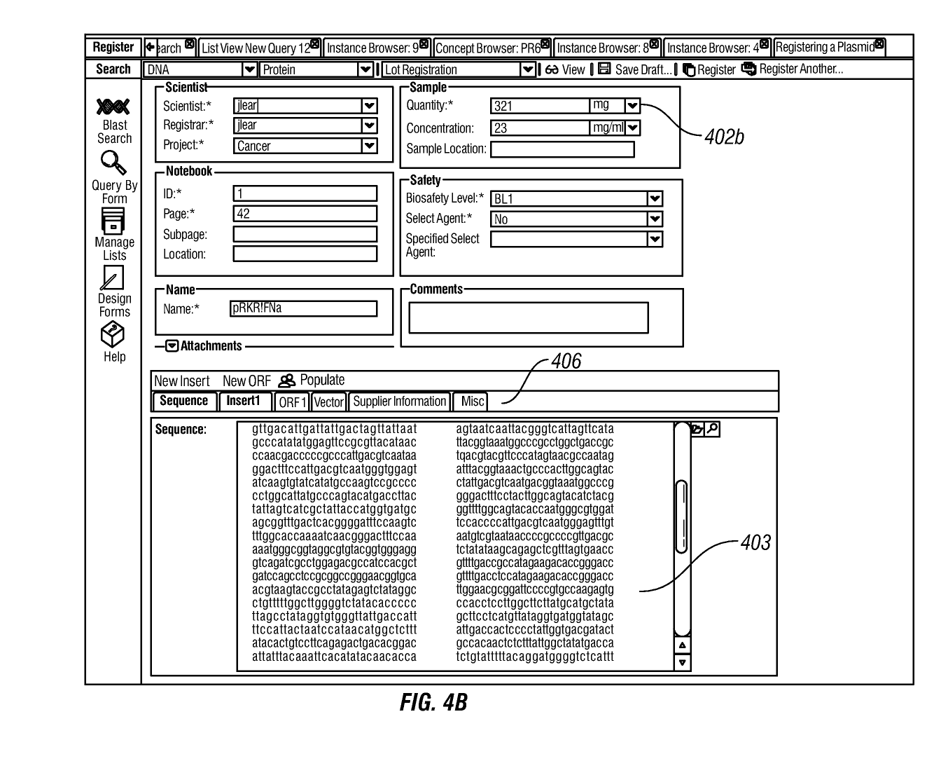

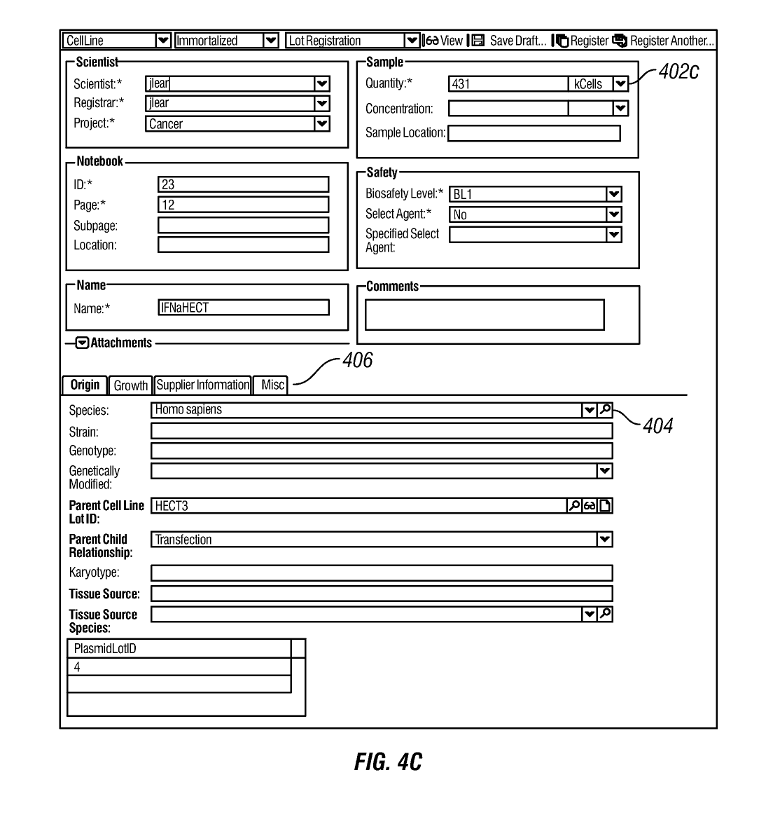

Turning now to a specific example related to a database of biological entities, FIGS. 4A-4C illustrate example user interfaces (partially filled in by a user) for registering proteins, plasmids, and cell line lot entities respectively. In each case, the screen includes fields for entering lot attributes (such as quantity 402) on the top, and instance attributes (such as sequence 403, species 404, and tissue source 405) on the bottom. Tabs 406 are shown which may be selected to display additional instance attribute fields for a given class. These may include preparation information, supplier information if the lot was obtained from a third party, and other attributes that are relevant to the class of entity being registered. Whether a user registers a lot instance, a generic instance, or a virtual instance may be determined by the attributes that are given values during the registration process.

### Concept Entities, Identity, and Uniqueness

In each case of instance registration, some of the instance attributes may also correspond to concept attributes. Using the protein lot registration screen of FIG. 4A as an example, it may be noted the species field 404 and sequence field 403 are highlighted. In this embodiment, these are the attributes defining a protein “concept.”

Although the system may be configured to directly accept registration of concept entities, this need not, and generally is not the case. Instead, it is an important feature of many invention embodiments that concept entities are automatically created in response to the first instance entity registration that includes new values for one or more of the designated concept attributes. Thus, if the lot entity of FIG. 4A were the first registration of an instance entity in the Protein class having the illustrated species and sequence, the system would automatically generate a concept entity having the same two attributes. The new concept entity may be assigned an attribute of a unique corporate identifier, which may be referred to as a “moniker,” which may then become an attribute of the lot entity. Thus, the attributes of the lot entity corresponding to a concept are stored again in a concept entity, which becomes another record managed by the system. As additional instance entities of the Protein class continue to be stored in the database over time, these concept attributes may be compared to existing previously created concept entities of the Protein class. If a match is found, the newly registered lot instance may be associated with the same corporate identifier as the corresponding existing concept entity. If no match is found, a new concept entity will be created with a new unique corporate identifier, which will also be associated with the newly registered lot. The end result is that each instance entity registered in the system is associated with a corresponding concept entity, and all instance entities having the same concept attributes are associated with the same concept entity. Each concept entity will be unique, and each instance entity will be unique if it is the only instance associated with a particular concept entity. As used herein, different instance entities that are associated with the same concept entity are not called “unique,” even though, for example, the different lots represented by the two instance entities would be physically different items. A “uniqueness check” in this system is thus a check for the existence of concept entities that an instance entity should be associated with. The ability of the system to capture relationships between entities in these embodiments, based on a business rules engine that defines uniqueness for each entity type results in very powerful relationship mapping.

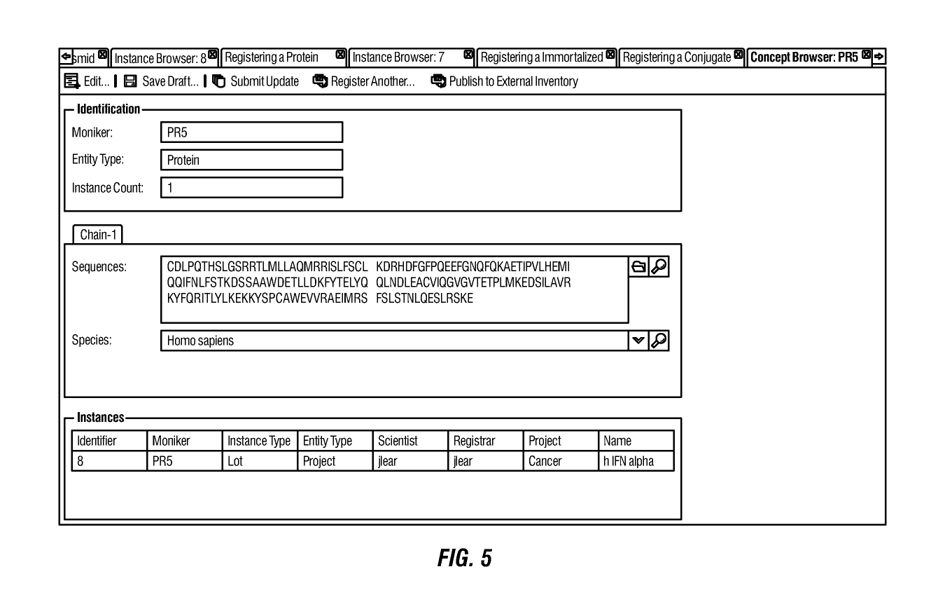

FIG. 5 illustrates a display of a Protein concept entity. In this example, the user may use a concept browser tool to view the Protein class concept entity having a corporate identifier of PR5. This allows the user to view the entity type (e.g. class), the attributes of sequence and species that define the concept, and a description of all instance entities (e.g. lot entities) that share the same concept attributes. In this example, there is one instance entity having identifier 8 that corresponds to this concept. The lot entity having identifier 8 is then said to have an identity relationship with the concept entity having corporate identifier PR5.

A portion of the business rules, which may be referred to as the identity rule set, may be used to match entity instances to entity concepts and define the response of the system to additions of, or changes to, instance entities. These can be more complex than the simple attribute check of the above example. Generally, when checking for uniqueness, instance attributes are evaluated for whether they meet the criteria that define a concept, where the criteria is made part of one or more business rules that are applied upon instance entity registration.

When an instance entity is associated with a concept entity, an identity relationship is created describing the association between the instance and concept. If a concept entity is redefined, the relevant instance entities may be identified and checked. If the data of an instance entity is altered, these rules may ensure that the entity instance still obeys the rule associating it with the concept entity. If the entity no longer falls within the previously identified concept, it can be associated with another preexisting concept entity, or to a newly created concept entity. Thus, if the instance or concept is no longer unique, it should be merged.

As described above, the identity rule set may assign corporate identifiers, or “monikers” to distinguish the different concept entities. In some embodiments, four main types of rules may be used to determine whether a new corporate identifier and concept should be created or the instance entity may be said to be the same as an existing concept entity in the system: Entity type, Attribute values, Matching attribute values, and Relationship rules.

Entity type rules may be generally directed to the present moniker assignment of the entity. As part of this process, these rules may employ a “ConceptInfo” object to contain information about which particular rules have been applied and the results of those rules. As one example, in the biological registration context, a rule may be designed to assign a unique corporate identifier to all polyclonal antibody entities in lieu of any further identifying information.

```
rule “All Polyclonals are assigned a Moniker”
  when
    Entity(entityType == “Polyclonal” && hasMoniker == false)
  then
    insert(new ConceptInfo(“All Polyclonals are assigned a Moniker”, 4) );
```

Attribute value rules may evaluate whether specific attributes of the entity being registered have certain values. In the biological context, the moniker for “Immortalized CellLines with Tissue Source and Species” may be defined as follows:

```
rule “Immortalized CellLine with Tissue Source”
  when
    $e : Entity(hasMoniker == false && entityType == “Immortalized”)
    eval($e.hasAnnotation(“TissueSource”));
    eval($e.hasAnnotation(“TissueSourceSpecies”));
  then
    insert(new ConceptInfo(“Immortalized CellLines with defined
  Tissue Source & Species are assigned a Moniker”, 1) );
end
```

In some embodiments, the rules will determine that an entity corresponds to a concept if certain attributes of the entity and the concept have the same values. In the following example determining the uniqueness of a plasmid, a module named “UniquenessService” is called that searches existing concept entities and returns the primary key of any concept entities that exist that match the criteria determined by the rule. The ConceptInfo object may return with text describing the results of the rule.

```
rule “Plasmid Uniqueness Rule”
  when
    $e : Entity(entityType == “Plasmid”)
    eval($e.hasAnnotation(“NucleotideSequence/Sequence”));
  then
    insert(new ConceptInfo(“Plasmid Nucleotide Sequence is unique”, 1,
      uniquenessService.existingConcepts(
        $e.getObjectType( ),
        UniquenessService.RelatedProcessing.NONE,
        $e.getEntityType( ),
        $e.getAnnotation(“NucleotideSequence/Sequence”)),
      $e.getAnnotation(“NucleotideSequence/Sequence”) ));
end
```

In these examples, the business rules produce results that the system then uses to define actions that are then taken on the database information such as the creation of concept entities, assigning corporate identifiers, etc. For example, if the UniquenessService module returns the primary key of an existing concept that matches an instance entity being registered according to the rule applied for that entity, the newly registered instance may be associated with that concept entity, and no new concept entity will be generated. On the other hand, if the UniquenessService module finds no matching concept, a new concept entity may be generated for the newly registered instance.

Researchers and database designers may establish these rules prior to the system's deployment. The following tables provide some examples of attribute type rules that may be used in some embodiments for registration of various entity classes in biological registration context:

TABLE 1
Entity Rules - Proteins

| If | And | Then |
|---|---|---|
| Amino acid sequence | | New moniker is |
| and species | | assigned |
| combinations are | | |
| unique across all | | |
| chains | | |
| Entity has been | Treatment is | Moniker of the |
| isolated from | purification or amino | previously |
| another protein | acid derivatization | isolated protein |
| lot | but not peptidase | is inherited |
| | treatment or chemical | |
| | conjugation | |
| Entity has been | Combination of | Same moniker |
| isolated from | peptidase treatment | assigned to all |
| another protein | and chemical | |
| lot | conjugation matches | |
| | another protein | |
| | isolated from the | |
| | same source protein | |
| Entity has been | Combination of | New moniker is |
| isolated from | peptidase treatment | Assigned |
| another protein | and chemical | |
| lot | conjugation does not | |
| | match other proteins | |
| | isolated from the | |
| | same source protein | |

TABLE 2
Entity Rules - DNA

| If | And | Then |
|---|---|---|
| Circular nucleotide | | New moniker is assigned |
| sequence is unique | | |

TABLE 3
Entity Rules - Antibodies

| | | |
|---|---|---|
| If | And | Then |

All

| | | |
|---|---|---|
| Multiple antibodies | Chemical conjugation | New moniker is |
| isolated from same | is unique | assigned |
| source protein | | |
| Entity isolated from | Other entities have | Same moniker |
| hybridoma cell line | been isolated from | assigned to all |
| | identical hybridomas | |

Polyclonal

| | |
|---|---|
| No matching supplier | New moniker is |
| information is provided | assigned |

FabFragment

| | | |
|---|---|---|
| Multiple FabFragments | Peptidase Treatment | New moniker is |
| isolated from same | is unique | assigned |
| source protein | | |

Monoclonal, SingleChain, Singledomain, Synthetic

| | | |
|---|---|---|
| Entity isolated from | No other antibodies | New moniker is |
| hybridoma cell line | have been isolated | assigned |
| | from this hybridoma | |

FabFragment, Monoclonal, Synthetic

| | | |
|---|---|---|
| Heavy chain amino acid | Light chain amino acid | New moniker is |
| sequence and species | sequence and | assigned |
| are unique | species are unique | |

SingleChain, SingleDomain

| | |
|---|---|
| Chain amino acid | New moniker is |
| sequence and species | assigned |
| are unique | |

TABLE 4
Entity Rules - Cell Lines

| If | And | Then |
|---|---|---|
| ATCC Catalog number | | New moniker is |
| is unique | | assigned |
| Parent Cell Line | Parent child relationship | Parent moniker is |
| Lot ID is supplied | is thaw | assumed |
| Parent Cell Line | Parent child relationship | New moniker is |
| Lot ID is supplied | is not thaw | assigned |
| Sub type is | Parent child relationship | New moniker is |
| hybridoma | is fusion | Assigned |
| Sub type is | Tissue source and tissue | New moniker is |
| immortalized | source species are | Assigned |
| | specified | |

TABLE 5
Entity Rules - Multi-Component Entities

| If | And | Then |
|---|---|---|
| Entities and ratios | | New moniker is assigned |
| listed in Components | | |
| table is unique | | |

TABLE 6
Entity Rules - Vaccines

| If | And | Then |
|---|---|---|
| No matching supplier | | New moniker is |
| information is | | assigned |
| provided | | |
| Sub type is Conjugate | Carrier supplier | New moniker is |
| | information is unique | assigned |

TABLE 7
Entity Rules - siRNA

| If | And | Then |
|---|---|---|
| Modified sequence and Oligo | | New moniker is |
| Type combinations are | | assigned |
| unique across all oligos | | |

TABLE 8
Entity Rules - Lot Information

| If | Then |
|---|---|
| Attributes required by meta | Registration cannot proceed |
| data not provided | |
| Quantity is less than 0.005 | Registration cannot proceed |
| Unit provided with no value | Registration cannot proceed |
| Plasmid has more than | Registration cannot proceed |
| 16000 bases | |
| Verification or production | Registration cannot proceed |
| date is in the future | |
| External Lot ID provided | Validity is checked and external |
| | value used where appropriate |

TABLE 9
Entity Rules - Generics

| If | Then |
|---|---|
| Entity is a Generic | Lot ID is based on the |
| | Name of the entity |

TABLE 10
Entity Rules - Virtuals

| If | Then |
|---|---|
| A matching virtual | Registration cannot proceed |
| already exists | |

TABLE 11
Entity Rules - Monikers

| If | And | Then |
|---|---|---|
| Lower priority rules | | They are ignored |
| have no matches | | |
| Lower priority rules | Higher priority rules | The higher priority |
| have matches | have no matches | rules are ignored |
| Some higher priority | Some higher priority | Those without |
| rules have matches | rules have no matches | matches are ignored |
| Supplier information | No appropriate moniker | A new moniker is |
| is provided | exists | assigned |

TABLE 12
Entity Rules - Post-Registration and Curation Rules

| If | And | Then |
|---|---|---|
| Biosafety level is | | Email is stent to |
| higher than BL1 | | the safety officer |
| Curation is | | Email is sent to |
| required | | the curator |
| Edits are approved | | Email is sent to |
| by the curator | | the scientist |
| Edits are rejected | | Email is sent to |
| by the curator | | the scientist |
| Edits are rejected | | Email is sent to |
| by the scientist | | the curator |
| A scientist makes | | Curation is entered |
| edits to an | | |
| identifying | | |
| attribute | | |
| A scientist edits | Another plasmid | Curation is entered |
| or enters a | already exists with an | |
| plasmid | identical sequence | |
| | irrespective of start | |
| | point | |
| A lot is in | Edits are attempted | Warning message is |
| curation | | displayed |
| A new entity is | A different type of | Curation is entered |
| registered | entity already exists | |
| requiring a new | with the same moniker | |
| moniker | level information | |

TABLE 13
Entity Rules - User Rules

| If | And | Then |
|---|---|---|
| The user has | The user owns | They can edit the record |
| privileges | the lot | |
| The user is a | | They can approve or reject |
| curator | | records in curation |

TABLE 14
Autopopulation Rules - Proteins and Antibodies

| If | And | Then |
|---|---|---|
| A Plasmid Lot ID | The referenced | Allow selection of |
| is provided for | plasmid has an ORF | the ORF |
| a Chain | | |
| A Plasmid Lot ID | An ORF is specified | Allow autopopulatin of |
| is provided for | | the Name for the Chain |
| a Chain | | |
| A Plasmid Lot ID | An ORF is specified | Allow autopopulation of |
| is provided for | | the Amino Acid Precursor |
| a Chain | | Sequence for the Chain |
| A Plasmid Lot ID | An ORF is specified | Allow autopopulation of |
| is provided for | | the calculated Average |
| a Chain | | Molecular Weight of the |
| | | Amino Acid Sequence of |
| | | the Chain |
| A Plasmid Lot ID | An ORF is specified | Allow autopopulation of |
| is provided for | | the calculated |
| a Chain | | Theoretical Molecular |
| | | Weight of all the Amino |
| | | Acid Sequences of all |
| | | the Chains |

TABLE 15
Autopopulation Rules - Antibodies

| If | And | Then |
|---|---|---|
| Prepared from | | Allow autopopulation of the |
| Protein Lot | | Heavy and Light Chain Species |
| ID is supplied | | |
| Prepared from | Lot ID is for a | Allow autopopulation of the |
| Protein Lot | FabFragment | FabType |
| ID is supplied | antibody | |
| Prepared from | | Allow autopopulation of the |
| Cell Line Lot | | Heavy and Light Chain Species |
| ID is supplied | | |
| Prepared from | | Allow autopopulation of the |
| Cell Line Lot | | Heavy and Light Chain Isotype |
| ID is supplied | | |

TABLE 16
Autopopulation Rules - Antigen Sections

| If | And | Then |
|---|---|---|
| Cell Line Lot ID | | Allow autopopulation of |
| is supplied | | the Cell Line Name |

TABLE 17
Autopopulation Rules - DNA

| If | And | Then |
|---|---|---|
| A DNA nucleotide | The Range Start and | Allow autopopulation of |
| Sequence | Range End position | the Insert Sequence |
| is provided | of an Insert are | |
| | specified | |
| A Vector Plasmid | The plasmid has a | Allow autopopulation of |
| Lot ID is provided | sequence | the Vector Sequence |
| A Vector Plasmid | | Allow autopopulation |
| Lot ID is provided | | of the Vector Name |
| A DNA nucleotide | The Start and End | Allow autopopulation |
| Sequence is | position of an ORF | of the ORF |
| provided | are specified | nucleotide sequence |
| A DNA nucleotide | The ORF nucleotide | Allow autopopulation |
| Sequence is | sequence is | of the Start and End |
| provided | provided | positions of the ORF |
| An ORF nucleotide | | Allow autopopulation of |
| Sequence is | | the ORF amino acid |
| provided as a | | Sequence |
| multiple of | | |
| 3 bases | | |
| An ORF amino acid | | Allow autopopulation of |
| Sequence is | | the ORF Theoretical |
| provided | | Molecular Weight |
| A DNA nucleotide | The Start and End | Allow autopopulation of |
| Sequence | position of an ORF | the ORF nucleotide |
| is provided | are specified with | sequence using the |
| | End < Start | complement strand |

Where more than one attribute value is used to determine identity, its context may become important relative to other attributes. For example, the Species of a Protein Chain is only relevant to the Sequence with which it is associated.

In many cases the context can be assumed from the attribute paths, which is the case with antibodies. For proteins, an AttributeGroup may be defined to maintain the context of the related attributes.

The following example shows the rule for a protein chain, where the combination of sequence and species is used to determine the identity.

```
rule “Protein Uniqueness Rule”
  when
    $e : Entity(entityType == “Protein”)
    eval(!$e.hasAnnotation(
      “Preparation/IsolatedFromProteinPreparation/
      ChemicalConjugation”));
    eval($e.hasAnnotation(“Chain/AminoAcidSequence/Sequence”));
    eval($e.hasAnnotation(“Chain/Species”));
  then
    List<Annotation>allAnnotations = new ArrayList<Annotation>( );
    allAnnotations.addAll(
      $e.getAnnotations(“Chain/AminoAcidSequence/Sequence”));
    allAnnotations.addAll($e.getAnnotations(“Chain/Species”));
    insert(new ConceptInfo(“Protein Chains & Species are unique”, 1,
    uniquenessService. existingConcepts(
      $e.getObjectType( ),
      UniquenessService.RelatedProcessing.THROUGH_IDENTITY,
      $e.getEntityType( ),
      new AnnotationGroup(“Chain”, allAnnotations)),
    allAnnotations));
end
```

This rule uses two techniques to determine uniqueness: 1) There can be any number of chains for the entity being registered, so a list of sequence and species attributes is constructed and 2) Each Species attribute needs to maintain its relationship with its Sequence so that an AnnotationGroup is used to keep the attributes together.

The following uniqueness rule determines the appropriate moniker based on the relationships. Where attributes are referenced by the rules, their path is used to refer to their presence (hasAnnotation (“Lot/Quantity”)) or value (getAnnotationAsFloat(“Lot/Quantity”)<=0.05. Attribute paths are very similar to XPaths, a raw XPath syntax is also supported for precise control over access to attributes.

```
rule “Hybridoma Lots are Unique”
  when
    exists Antibody( ) #If this exists we have an Antibody
    $e: Entity( )
    eval($e.hasAnnotation(“Preparation/IsolatedFromCellLine/CellLineLotID”));
    #See if the lotID entered is that of a published hybridoma with a moniker
    $hybridoma : Entity((entityType == ‘Hybridoma’) && (hasMoniker == true)) fr
        entityService. getLotPkForLot($e.getAnnotationAsString(
    “Preparation/IsolatedFromCellLine/CellLineLotID”)), 1);
  then
    # the moniker of the Antibody produced from a Hybridoma is based on
    # the identity of the Hybridoma
    insert(new ConceptInfo(true, “Hybridoma Lot is unique”, 3,
      uniquenessService.existingConcepts(
        $e.getObjectType( ),
          UniquenessService.RelatedProcessing.THROUGH_IDENTITY,
        $e.getEntityType( ),
        newAnnotation(0,“Preparation/IsolatedFromCellLine/CellLineLotID”,
          $hybridoma.getLotID( )) ),
        new Annotation(0,“Preparation/IsolatedFromCellLine/CellLineLotID”,
$hybridoma.getLotID( ) ));
end
```

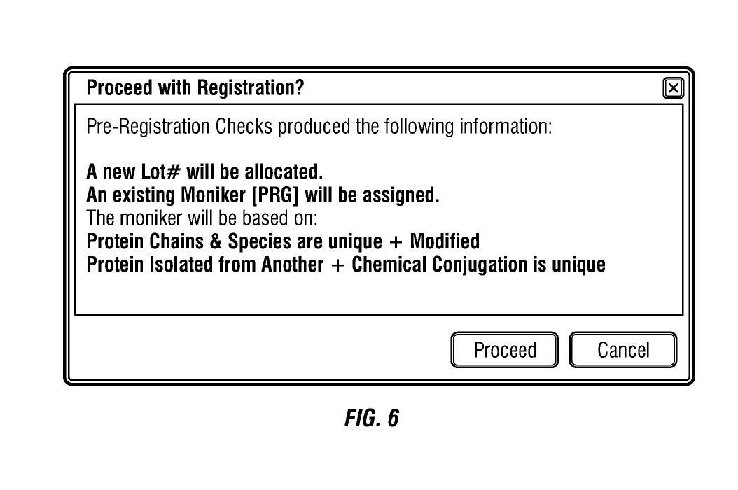

As shown in FIG. 6, the results of the identity check analysis may be reported back to the scientist to inform the scientist of the results prior to the scientist proceeding with the registration. In the example of FIG. 6, the researcher is informed that the lot instance being registered corresponds to existing concept with corporate identifier PR6. This pre-registration check has many powerful advantages including informing a scientist that other lots of this entity have already been registered, as well as providing error checking. If a scientist attempts to register a new lot of an already registered entity, and the pre-registration engine informs the scientist that the entity is unique, the scientist can check all the fields to make certain there are no errors before completing the registration. Also note that the information content of an entity can affect what business rules are used to determine uniqueness. In the registration shown above, the uniqueness of the entity is based on the protein sequence and species. However, if sequence were not available, the system could use purchasing information such as vendor and catalog number to determine uniqueness. These identity business rules may have a hierarchy. In this case, purchasing information may be used only if sequence information was not available.

### Class and Entity Relationships

Referring back to FIG. 3, relationships 305 and associations 307 may be defined between classes 302a-b and entities 308a-b to recognize a variety of correlations between the attributes of each. Upon creation of a new entity, the system can review the relationship definitions, and make record of any matches with the new record. Thus, relationship definitions can exploit the class hierarchy; a relationship definition on a parent class may also apply to all child classes, and they can also be defined for discrete child classes. Relationships can be inherited, mandatory, or optional, and they can have asymmetry (A may cause B but B always results from A).

Relationships between entities generally can be classified into three types, denoted herein as factual, expected, and potential. Factual associations are derived from actual experimental events. A factual association may, for example, state that “cell line A was used to produce protein B.” Expected associations may be derived from expected future activity, such as “plasmid A was created to produce protein B.” This can be a valid association even if protein B is never actually produced with this plasmid. Potential associations can apply to concept entities, and thus may be used across all instance entities of a particular concept entity. For example, “gene A may encode protein B.” The concept entity for Gene A may encode the protein, but not all instance entities of this gene may do so. This relationship is a true statement for all instances of the gene A concept, even if the actual fact of encoding protein B may not hold for all instances. Such relationships may also be defined between attributes of entities rather than between the entities as a whole.

When an entity is redefined by a change in attributes, all relevant entity instances may then be identified and their proper dependency again determined. Thus, if entity instance data were altered, this process ensures that the entity instance still obeys the rule associating it with a given entity concept. This revalidation of entity relationships may occur for a variety of reasons. Incorrect information, as when the data input at registration contains errors and must be corrected, may initiate revalidation. Changes to the rules, as when previous uses of an updated rule may need to be confirmed or changed, may provoke revalidation. The addition of new rule information may also provoke revalidation, as when a new rule or new data for a rule is added to an Entity concept or instance. In this case, the association will need to be confirmed. If the instance is no longer unique it may be merged with an existing concept.

### Example Embodiments of Entity and Relationship Creation

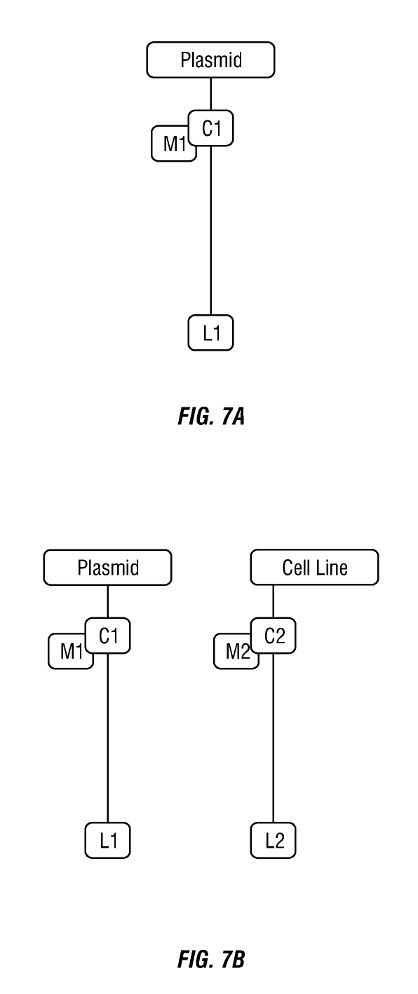

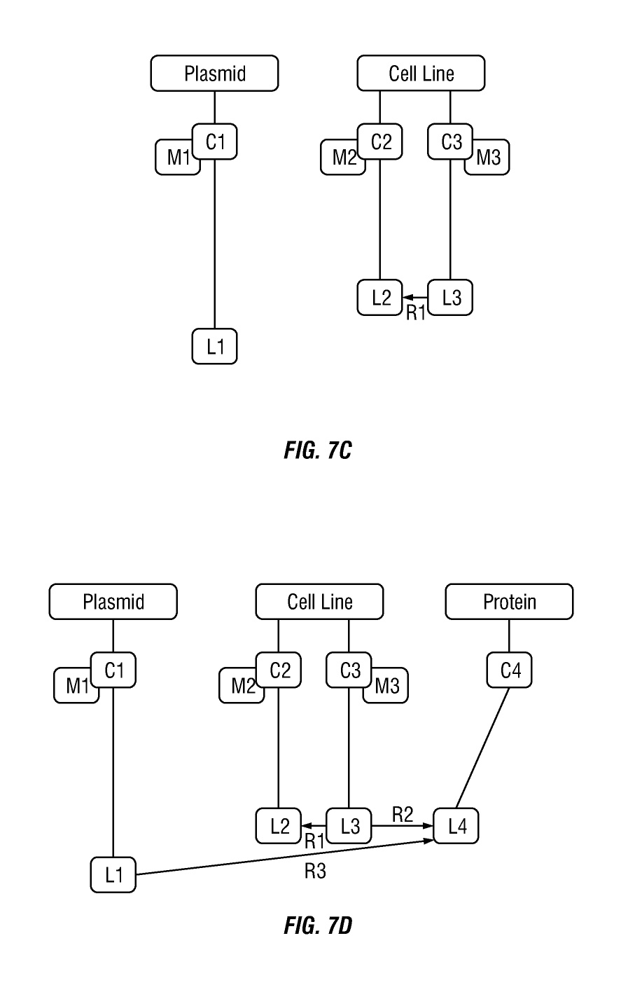

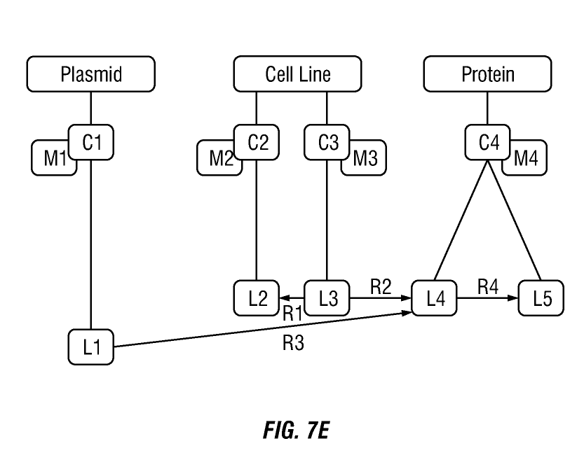

FIGS. 7A-7D illustrate a workflow involving the creation of a plasmid that is used to transfect a cell line and then produce a protein.

FIG. 7A first illustrates the data structures generated in one embodiment wherein the system receives a new plasmid entry and executes a series of rules to update the database. Initially, the user, e.g. a scientist, enters a plasmid lot into the system which is represented in the system by lot instance entity L1. In this embodiment, the rules specify that uniqueness checks are to be performed at registration. In this example, the rules determine that the entity is unique, and a new concept entity is created C1, and the corporate identifier M1 is assigned to C1.

Turning now to FIG. 7B, a cell line lot is purchased from a supplier, from which a cell line lot instance entity is registered L2. As the system has not encountered the cell line entity L2 before, a new concept entity is created C2. This entity is identified with supplier information, and a corporate identifier is assigned to C2 (M2).

In FIG. 7C, cells from the cell line represented by entity L2 are transfected with the plasmid represented by entity L1. The user then registers the transfected cell line to create instance entity L3. As it has not been encountered before an entity concept is created C3. A corporate identifier is assigned to C3 (M3). A relationship (“is parent of”) denoted R1 is instantiated between L3 and L2 (R1). The arrows of relationships designate the direction in which the relationship refers. Attributes for L3 may be acquired from L2 and/or L1 according to business rules for autopopulation, described further below.

In FIG. 7D, the user has isolated a protein from the transfected cells represented by lot instance entity L3 and registers this protein lot in the registration database as lot instance entity L4. Again, no corresponding concept entity is found to exist, so a new protein concept entity C4 is created. In this example, no sequence information for the protein is provided, so no corporate identifier is assigned to the concept entity C4. A relationship “is produced by” is instantiated between L3 and L4 denoted R2 to indicate that the protein was produced by the transfected cells. A relationship “is encoded by” is instantiated between L1 and L4 denoted R3 indicating the protein is encoded by the plasmid.

Referring to FIG. 7E, the scientist-user may subsequently create a new lot instance entity L5 by purification of the lot represented by entity L4. As L5 is derived from L4, business rules may dictate that it shares the same concept with L4. Accordingly, no new concept entity is created, and the new lot entity L5 is associated with existing concept C4. In the example of FIG. 7E, the scientist added sequence information as an attribute of L5. Business rules may now dictate that when this information is provided, a corporate identifier M4 is now assigned to C4. A relationship “is derived from” denoted R4 may further be instantiated between L5 and L4.

As described above, the reaction of the system to the registration of entities such as L1 through L5 will be controlled at least in part by the defined business rules, which have as inputs the attributes of the entities being registered. The result of business rule application may include the creation and storage of new entities, the creation and storage of relationships between entities, and the creation and assignment of corporate identifiers to entities. It will be appreciated that a wide variety of rules defining what actions are taken under what conditions may be created, and FIGS. 7A-7E provide only a few examples.

As another example related to FIGS. 7A to 7E, it may be that the scientist-user created the plasmid represented by L1 to produce a particular protein. This may be entered as an attribute of plasmid entity L1. Based on the scientist-user's input in creating the plasmid lot entity, the system may automatically generate a protein entity according to one of the business rules. In this case, the new protein entity would be a virtual instance entity because no lot of this protein is being registered. This is an example of the system creating one or more additional instance entities that have a relationship with the instance entity being registered. The system may include a rule that generates an “expected” association between the plasmid and the protein. If that is the case, the association may state “Plasmid A was created in order to produce protein B”, even though Plasmid A may never actually be used for this purpose. If experimental error has mistakenly predicted that the plasmid will generate the protein, the system may be updated by the business rules at a later time when attributes are modified. A “potential” association may also be created between the concept entities associated with the plasmid and the protein.

### Relationship Display

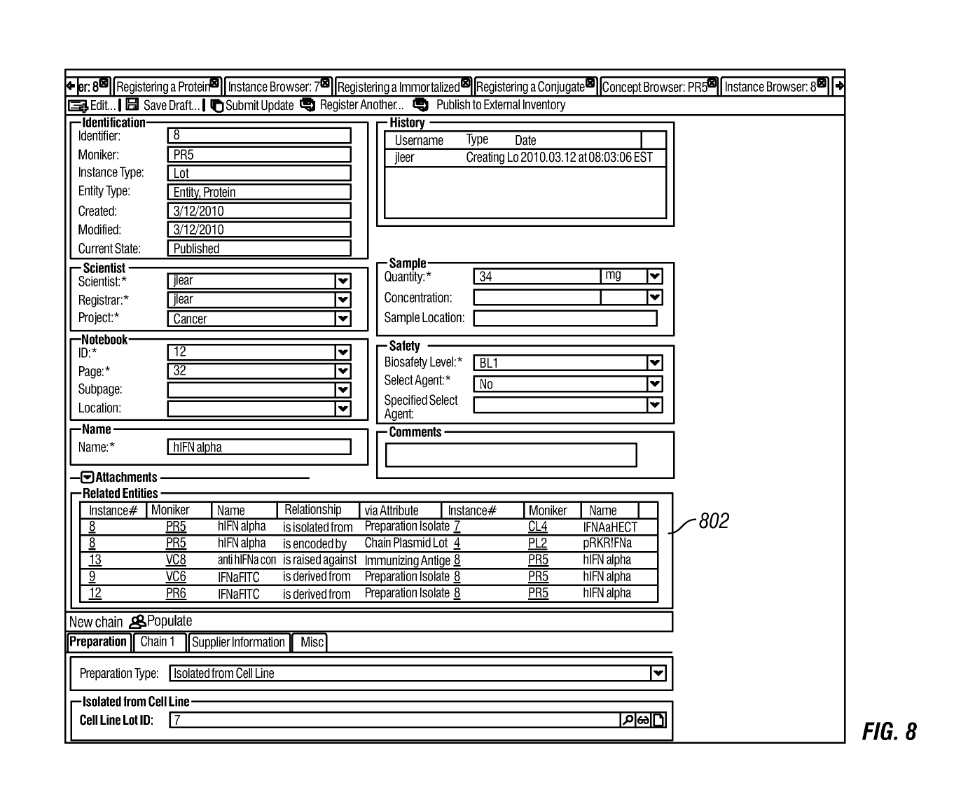

When a user retrieves a record corresponding to a selected entity, some or all of the relationships created by the system may be displayed to the user. An example of this display is shown in FIG. 8. In this view, a Related Entity pane 802 is displayed along with the other attribute information for the entity. The Related Entity pane sets forth the other entities in the database that are related to the entity being viewed, as well as a statement of the relationship. In this example, the entity being viewed in an interferon alpha protein with identifier 8. The Related Entity pane 802 reveals that this protein was isolated from the cell line IFNaHECT (lot ID 7), it was encoded by plasmid pRKRIFNa (lot ID 4), it was used as an immunizing antigen in the development of an anti-hIFNa conjugate vaccine (lot ID 13), and there were two lots of FITC conjugated protein that were made from this lot. From this window, the user can, if desired, link directly to the related entities to view their attributes, and see further along the chains of related entities.

### Database Queries

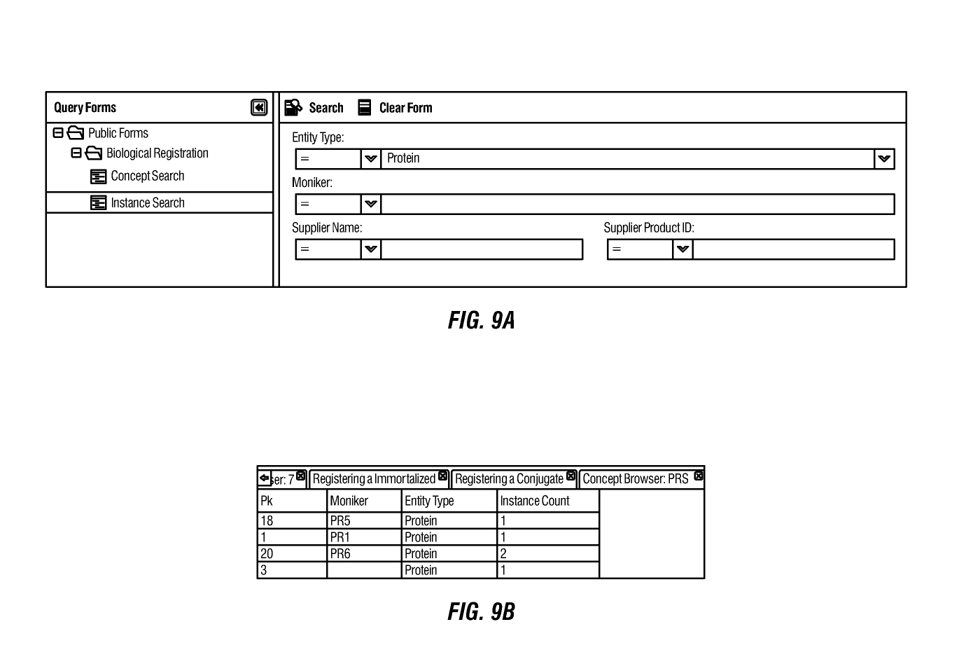

In many advantageous embodiments, the system provides powerful search capabilities, not only at the instance level such as searching for lots of a particular item, but also at the concept level. FIG. 9A shows a portion of a concept search screen and FIG. 9B shows the results of the search of FIG. 9A. In this example, a search for all concepts in the Protein class is performed. It will be appreciated that a variety of search fields in addition to those illustrated could be provided, including sequence, species, etc.

In the results screen of FIG. 9B, four results are produced, showing how many instances there are for each concept fulfilling the search criteria. Selecting concept moniker PR5, for example, will produce the screen display shown above in FIG. 5. This display of FIG. 5 allows a view of the concept attributes, and provides specific information about all the instance entities that correspond with this concept.

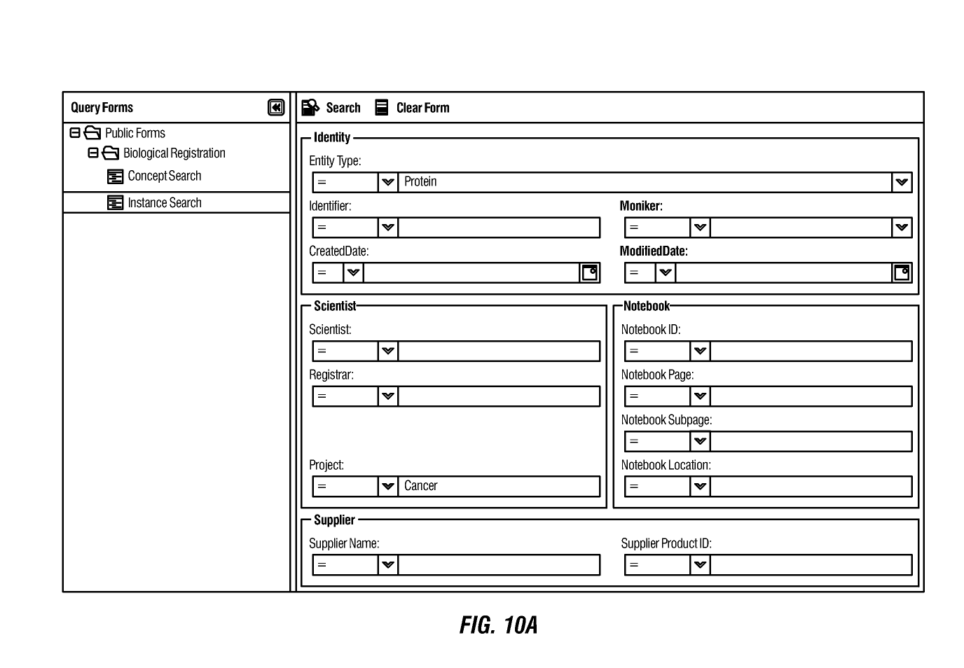

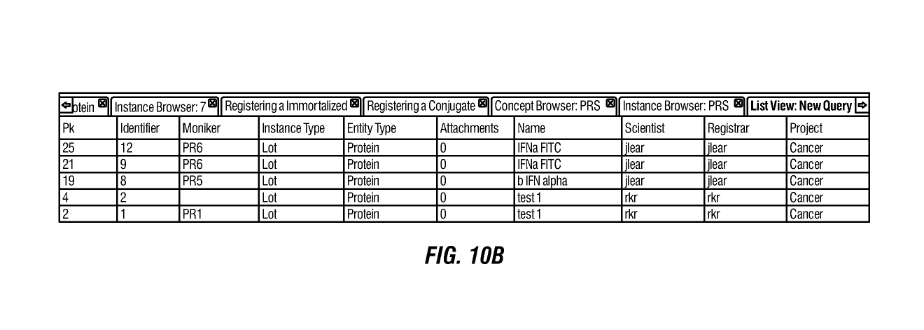

A search over instance entities can also be performed via an instance entity search screen. An example of this is set forth in FIGS. 10A and 10B, where FIG. 10A shows an instance entity search screen, and FIG. 10B shows the results of the search of FIG. 10A. In this example, a search for all instance entities in the Protein class submitted in the Cancer project will be searched for. As noted above, it will be appreciated that a variety of search fields in addition to those illustrated could be provided.

In the results screen of FIG. 10B, five results are produced. Selecting identifier 8, the third one down, will retrieve the screen shown in FIG. 8, which gives the attributes of the lot instance entity for the instance with identifier 8, as well as showing the relationships between instance 8 and other instances, as described above.

### Validation

Rules may determine the functionality by which users interact with the system. Validation rules generally determine at least in part whether or not an instance may be registered. The following example uses meta-data defined for each attribute to determine whether it is required for registration.

1. rule “Minimum Amount Rule”
2. when
3. $e : Entity( )
4. eval($e.hasAnnotation(“Lot/Quantity”));
5. eval($e.getAnnotationAsFloat(“Lot/Quantity”) <= 0.005)
6. then
7. #actions
8. insert(new AnnotationError(“Lot/Quantity”, “Lot too small”));
9. end

This example rule is composed of several parts. Line 3 is a definition using the variable e to bind the entity being registered, this allows the same entity to be referred to later in the rule expression. Line 5 asserts a condition that the entity must have a Quantity field specified to continue evaluating this rule. Line 6 evaluates the value of this attribute. If the value of this attribute is less than the specified amount, then the rule fires. Line 9 generates an error message when all of the conditions are met.

The AnnotationErrors produced are used to indicate to the application that a validation error has occurred. An object of this type is inserted into working memory for later retrieval. In this example, the Quantity attribute is flagged as having an inappropriate value and a free text reason is given. In the web client interface, the specified field may be highlighted in red and the tooltip will include the free text specified.

### Auto-Population Rules

The Biological Registration System can use rules to automatically derive (“autopopulate”) attribute values according to other attributes already defined in the system.

Auto population may be performed in several stages: All available attributes and their values are inserted into working memory, other attributes are derived from that information, and further iterations to derive new attribute values are carried out until no further new information can be generated. In some embodiments, in contrast to the rules which determine Moniker assignment, auto population rules do not function in isolation but cooperate to generate as much new information as possible.

All auto population rules should have the same type of consequence; a new Annotation is inserted into working memory with the path of the attribute to be populated with the value provided. Once all new information has been derived, the system uses the new Annotations to populate the attributes in the web client.

### Curation

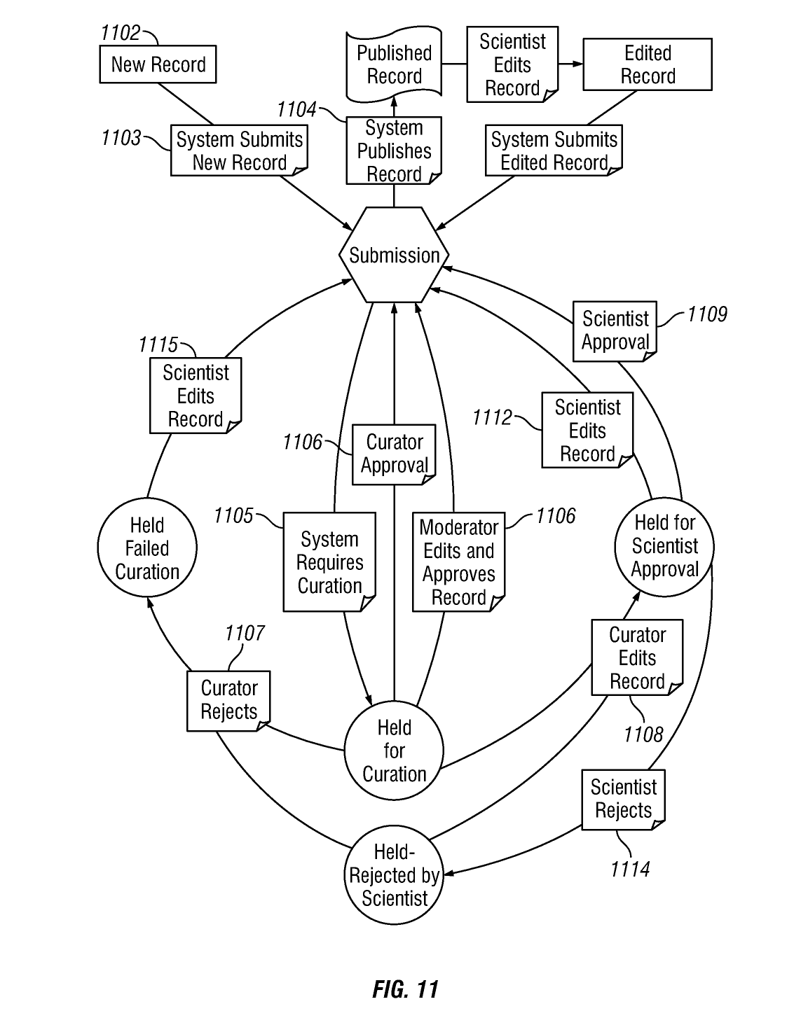

FIG. 11 illustrates a process flow diagram of a curation process found in certain embodiments. When records are created or edited they may be “published”, that is, approved for final entry into the system such that the business rules will operate upon them when considering other entries (for uniqueness checking, perhaps), and users may refer to them when browsing the database. In some embodiments, when a record is created or edited it is not automatically published. Instead, the record is tested by some of the business rules as part of the submission process. In some embodiments a new record can either be ‘saved as a draft’ or registered. A draft record is not subject to at least some of the business rules until it is submitted for registration. When a new record or a draft is submitted for registration the business rules are applied and if the record is acceptable it is sent directly to the “Published” state by the system. If the business rules require curation, the record is sent to the “Held for Curation” state and can follow the same lifecycle paths as edited records, such as approval, rejection, or correction.

The process may begin when a new entity record 1102 is created and input 1103 to the system for registration. As discussed, the entity may be a lot, virtual, or generic. Business rules are then applied and used to determine whether the record should be published 1104 or curated 1105. The record can then be approved, rejected, or edited by a curator, or edited and approved by a moderator. If approved, the document is returned 1106 to the business rules where it is again determined if curation is necessary or publication may occur. The curator may instead reject the record 1107, or edit the record 1108, and then submit to scientist for review. In some embodiments, the communication is all handled via email, sent either directly by each reviewer or via direction of the business rules.

The scientist may generally: approve the changes and return the record for application of the business rules 1109; edit the record and return the record for application of the business rules 1112; or reject the curators changes 1114 and re-submit to the curator The document may be “held failed curation,” after which the scientist may edit the record 1115 and submit it again to the business rules. Thus, in many embodiments, there are four main situations in which a record enters submission and the business rules are applied: a new record is created, an existing record is edited, a record already in curation is approved, or a record already in curation is edited. In this manner, entry conflicts and irregularities that cannot be resolved by the business rules are resolved by the curator, moderator, or scientist.

What is claimed is:

1. A method for electronically recording and organizing entities on a computer system, wherein each entity is associated with one or more attribute values, the method comprising:
defining one or more concept entities comprising a corresponding one or more sets of concept entity attribute values;
receiving a plurality of field entries associated with an instance entity, the field entries comprising a plurality of instance entity attribute values;
determining, in the computer system, whether or not one or more of the plurality of field entries meet a defined criteria;
wherein if the one or more of the plurality of field entries meet the defined criteria, associating the instance entity with an existing concept entity; and
wherein if the one or more of the plurality of field entries do not meet the defined criteria, creating a new concept entity comprising a set of concept entity attribute values.

2. The method of claim 1 comprising:
comparing, in the computer system, at least some of the instance entity attribute values to one or more sets of concept entity attribute values to determine whether or not any of said one or more concept entities has the same compared attribute values as the instance entity,
wherein if the compared attribute values are the same for one of said concept entities and said instance entity, associating the instance entity with the concept entity having the same attribute values, and
wherein if the compared attribute values are not the same for any of said concept entities and said instance entity, creating a new concept entity having the compared instance entity attribute values as concept entity attribute values.

3. The method of claim 1, wherein the set of concept entity attributes of the new concept entity are derived at least in part from one or more of the plurality of field entries.

4. The method of claim 1, wherein at least one of the instance entity attribute values is inherited from a template.

5. The method of claim 2, wherein the instance entity represents a protein, and the compared attribute values comprise a species value and a sequence value.

6. The method of claim 1, comprising determining if an isolation treatment attribute of the instance entity is one of a first plurality of treatments and not one of a second plurality of treatments.

7. The method of claim 1, wherein business rules are applied in the determining step in an order of priority, the order of priority comprising a total order.

8. The method of claim 2, wherein which attribute values are compared depends on which attribute values are provided for the instance entity.

9. A computer-readable medium comprising program code configured, when executed by a computer processor, to perform the steps of:
associating one or more concept entities with corresponding one or more sets of concept attribute values;
receiving a plurality of field entries associated with an instance entity, the field entries comprising a plurality of instance entity attribute values;
determining whether or not one or more of the plurality of field entries meet a defined criteria;
wherein if the one or more of the plurality of field entries meet the defined criteria, associating the instance entity with an existing concept entity; and
wherein if the one or more of the plurality of field entries do not meet the defined criteria, creating a new concept entity with a set of concept entity attribute values.

10. A database implemented on a computer device, said database defining a plurality of entity classes, each of said classes being associated with a plurality of entities, each of said entities within a class comprising:
one or more instance entities comprising a corresponding set of lot attribute values and a corresponding set of instance attribute values; and
one or more concept entities comprising a corresponding set of instance attribute values;
wherein at least some of said instance entities are associated with a concept entity having at least some of the same instance attribute values.

11. The database of claim 10, wherein at least some of said concept entities are associated with a corporate identifier.

12. The database of claim 11, wherein at least some of said instance entities are associated with the corporate identifier of the concept entity having the same instance attribute values.

13. The database of claim 10, wherein at least some of said instance entities comprise lot instance entities.

14. The database of claim 10, wherein at least some of said instance entities comprise generic instance entities.

15. The database of claim 10, wherein at least some of said instance entities comprise virtual instance entities.

16. A method for electronically recording and organizing entities on a computer device, wherein each entity is associated with one or more attribute values, the method comprising:
receiving a new or edited entity record, the record comprising a plurality of field entries associated with a proposed instance entity, the field entries comprising a plurality of instance entity attribute values;
applying at least one business rule to the entity record to determine if curation is necessary;
curating the record, comprising:
making the record available for review and editing by a curator;
making the record available for review and editing by a scientist, based at least in part on the review of the curator; and
again applying the business rules to the entity record to determine if curation is necessary.

17. The method of claim 16, wherein making the record available for review and editing by a scientist, based at least in part on the review of the curator comprises sending an automated email notifying the scientist of the curator's edits.

18. A method for electronically recording and organizing entities on a computer system, wherein each entity is associated with one or more attribute values, the method comprising:
entering a plurality of lot attribute values into a user interface of the computer system;
entering a plurality of instance attribute values into a user interface of the computer system;
creating, in the computer system, an instance entity having the specified lot and instance attribute values; and
automatically creating at least one additional entity having at least some of the specified instance attribute values.

19. The method of claim 18, wherein said plurality of lot attribute values comprise one or more of a quantity, a location, a biosafety level, and a notebook identification.

20. The method of claim 18, wherein said plurality of instance attribute values comprise one or more of an amino acid sequence, a nucleotide sequence, and a species identification.

21. The method of claim 18, further comprising autopopulating fields of at least one created entity.

22. The method of claim 21, wherein autopopulating is performed as directed by one or more business rules.

23. A computer implemented system for electronically recording and organizing entities in a database, wherein each entity is associated with one or more attribute values, the system comprising:
means for defining one or more concept entities comprising a corresponding one or more sets of concept entity attribute values;
means for receiving a plurality of field entries associated with an instance entity, the field entries comprising a plurality of instance entity attribute values;
means for determining whether or not one or more of the plurality of field entries meet a defined criteria;
means for associating the instance entity with an existing concept entity if the one or more of the plurality of field entries meet the defined criteria; and
means for creating a new concept entity with a set of concept entity attribute values if the one or more of the plurality of field entries do not meet the defined criteria.

24. The system of claim 23 comprising:
means for comparing at least some of the instance entity attribute values to one or more sets of concept entity attribute values to determine whether any of said one or more concept entities has the same compared attribute values as the specific instance entity,
means for associating the instance entity with the concept entity having the same attribute values if the compared attribute values are the same for one of said concept entities and said specific instance entity, and
means for creating a new concept entity having the compared specific instance entity attribute values as concept entity attribute values if the compared attribute values are not the same for any of said concept entities and said specific instance entity.
